(19) United States
(12) Patent Application Publication
(10) Pub. No.: US 2008/0260935 A1
(43) Pub. Date: Oct. 23, 2008

(54) Reversitall anti-oxidant grape product, method of making, method of using, and apparatus for producing

(76) Inventor: Ahmad Alkayali, Lake Forest, CA (US)

Correspondence Address: Law Office of Terry L. Miller, 24832 Via SanFernando, Missionj Viejo, CA, 92692, US

(21) Appl. No.: 12/075,847

(22) Filed: Mar. 14, 2008

Related U.S. Application Data
(63) Continuation-in-part of application No. 11/787,512, filed on Apr. 17, 2007.

(51) Int. Cl. A23L 1/29; A23L 1/212; A23L 1/28

(52) U.S. Cl. 426/648; 426/655

(57) ABSTRACT

Reversitall is a unique anti-oxidant grape product, and includes a unique combination of beneficial organic chemicals, including trans-resveratrol, trans-viniferin, and oligostuibines. This product is produced from grape cane, red wine and raw grape juice. The grape product is usable as a food supplement having beneficial anti-oxidant properties. A method of making this food supplement includes solvent extraction from the grape cane, followed by vacuum drying without overheating the product. Another method for producing the product employs low temperature drying, and an apparatus to accomplishing this low temperature drying uses the surface of a body of heated but not boiling water to drive moisture off of the product. A method for using the food supplement involves human ingestion of desired amounts of the grape product as a daily food supplement.

### CROSS REFERENCE TO RELATED APPLICATION

This application is a Continuation-in-Part of U.S. application Ser. No. 11/787,512, filed 17 Apr. 2007, and the disclosure of which is incorporated by reference herein to the full extent necessary for a complete and enabling disclosure of the present invention.

### BACKGROUND OF THE INVENTION

1. Field of the Invention

This invention relates generally to food supplements containing beneficial or helpful chemical constituents, and particularly relates to dry powder, granular, or flake types of food supplements which are produced by extraction or drying natural plant materials. More particularly, this invention relates to a powerful anti-oxidant food supplement made from red grapes, from red wine, and from grape plant parts, by solvent extraction, or by drying without the use of elevated temperatures. For example, the plant source materials may include red wine, red grapes, red grape plant cane (i.e., stems, branches, and even leaves), red grape pulp (i.e., grape skins and seeds), white muscadine grapes, wine, and grape plant parts may be included, and especially the seeds of this white muscadine grape). By avoiding the use of elevated temperatures, the food values and nutritional constituents of the grapes and grape plant are preserved and are not oxidized or deteriorated by excessively elevated temperatures. Especially important is the use of grape cane, which historically has been discarded as trimmings of the grape vines in many vineyards. By use of the grape cane, the yield of beneficial product is increased, and the cost of this product is reduced.

2. Related Technology

Resveratrol is a phytoalexin produced by several plants and sold as a nutritional supplement. It has also been produced by chemical synthesis. A number of beneficial effects, such as anti-cancer, antiviral, neuroprotective, anti-aging, anti-inflammatory and life-prolonging effects have been reported in non-human species. Resveratrol is found in the skin of red grapes and in a constituent of red vine but apparently not in sufficient amounts to explain the so-called French paradox. That paradox relates to the low incidence of coronary heart disease in southern France despite a diet that is high in saturated fats. It has been found that Resveratrol increases the activity of a protein SIRT1, and that this protein significantly increases the lifespan of yeast and mice. Four stilbenes cis and trains resveratrol, and cis and trans piceid are similar and related, and are sometimes analyzed together as a group. Resveratrol produced by plants apparently has anti-fungal properties, and is found in widely varying amounts in grapes (primarily in the skins) and in the roots and stalks of giant knotweed and Japanese knotweed. Muscadine grapes and muscadine wines are also known to contain a good source of resveratrol.

Drying processes are known to product fruit leathers (i.e., a “ribbon” of moist flexible fruit product) by drying a moist product, such as fruit pulp, that includes the steps of floating a film of transparent material on a body of water, heating the water to maintain the water at a predetermined temperature, and placing the product to be dried on the floating film. The fruit leather product contains a considerable quantity of moisture, and is not a dry product. See, U.S. Pat. No. 4,631,837, issued 30 Dec. 1986 to Magoon. However, the production of dry granular, flake, or powder products from fruits and vegetables, and the preservation of the food values and nutrients in the fruits and vegetables by the avoidance of elevated processing temperatures is not disclosed in the conventional technology.

### SUMMARY OF THE INVENTION

In view of the deficiencies of the conventional technology, an object for this invention is to overcome or ameliorate one or more of those deficiencies.

An additional object for this invention is to provide a dry product food supplement from grapes, grape cane, and red wine, containing resveratrol and other beneficial constituents of the grape plant and fruit, as well as red wine.

The present invention provides a method for making or producing dry food supplements, and particularly for making a dry powder, granular, or flake types of food supplement which is produced by drying a moist puree source material without the use of elevated temperatures.

The method of drying a moist source material product, such as moist fruit pulp, or moist vegetable pulp, or other moist source material includes the steps of floating a film of water-impermeable, heat-transfer material on a body of heated water, maintaining the temperature of the water at a controlled elevated temperature sufficiently low that boiling is avoided, placing the product to be dried on the floating film, transferring heat from the water to the source or starting material while preventing flow of water from the body of water to the source material, directing a drying stream of air over the product pulp, and continuing the process until the product pulp has been reduced in moisture content to the extent that a substantially dry product or mass is produced. This dry product or mass is most usually in the form of a dry flake material or dry powder.

In preferred forms of the invention the floating material can be a flexible plastic and can be arranged on a conveyor system so that it moves across a reservoir of heated water carrying the pulp or other source material from a loading station to a removal station with the timing of the conveyor belt and the parameters of the product being applied to the conveyor belt being such that the product is applied in a suspension of solid particles in a liquid base (i.e., as a slurry, mash, suspension, or paste, for example) at one end of the conveyor and with the dried product being removed in its dried state at the second end of the conveyor. While certain preferred materials are known for use as the floating carrier film, it is sufficient if the carrier is transparent to infrared radiation (e.g., has a favorable heat transfer), is substantially impermeable to water, and is able to withstand temperatures in the range of the boiling point of water without shrinkage or deterioration of the material.

Red wine has long had a recognized benefit as an anti-oxidant. The active ingredient has increasingly been recognized as resveratrol as well as other beneficial constituents of the red wine. In order to study the anti-oxidation function of samples of material made according to this invention in comparison with resveratrol (95%, Rliizoma Polygoni Cuspidati P.E.) in mice, a Bromobenzene exposure study was conducted using mice. In this study, mice were randomly divided into 5 groups, 10 mice in each group, with one blank control group, one model control group, and three sample groups. The sample groups were given the test material according to the present invention. The control groups were given the same volume of water. After 30 days, blood was collected to test MDA levels and SOD activities. Thereafter, the mice fasted overnight, one hour after treating the mice with the samples, the sample groups and the model control group were given bromobenzene with 0.3 mol/l at a dose of 0.2 ml/20 g. After 20 hours, blood was again collected to test the perooxidation lipids (MDA) and antioxidase activity (SOD).

The appended FIGS. 4 and 5 respectively illustrate in the form of bar graphs the results of the SOD and MDA testing on these mice:

SOD (Superoxide dismutase) is an enzyme which is an important antioxidant defense in nearly all cells exposed to oxygen: Basically SOD is an antioxidant that the human and other animal's bodies produce themselves. SOD changes the molecule superoxide into water and hydrogen peroxide. Superoxide is one of the main “reactive oxygen species” (ROS) and is very toxic in the body. ROS's include peroxides, flee radicals, and oxygen ions. SOD works by out-competing the reactions of superoxide. So, when SOD works faster to break down superoxide than superoxide can cause toxicity in cells, then a body is protected from oxidation damage. Currently, “oxidative stress” is a considered a circumstance in which environmental stress dramatically increases ROS levels, damaging cell structures. When enzymes like SOD don't work (and if there is a severe lack of antioxidants from the diet) then the cells of the body are believed to be damaged by oxidants. This has been tested by genetically turning off SOD production in mice. Humans have 3 kinds of SODs in the body, each one helping in a different way. In the study, basically if SOD is higher, that means there is more damage because the body is making more SOD to counteract the damage done to the liver with the bromobenzene. Considering FIG. 5, the mice that took the new inventive product had the lowest amount of SOD activity (besides the control), which is a good thing.

Malonaldehyde (MDA) and 4-hydroxyalkenals, such as 4-hydroxy-2(E)-nonenal (4-HNE), are end products derived from the breakdown of polyunsaturated fatty acids and related esters. Malondialdehyde is the end-product of lipid peroxidation, which is a process in which reactive oxygen species degrade polyunsaturated lipids. This compound is a reactive aldehyde and is one of the many reactive electrophile species that cause toxic stress in cells and form advanced glycation end products. The production of this aldehyde is used as a biomarker to measure the level of oxidative stress in an organism. Less MDA means less lipids are being oxidized. In applying this to the experiment it would be expected that MDA levels will be lower with introduction of an effective anti-oxidant

As a summary, in this study the mice receiving the inventive grape product showed less MDA, which means less lipids were oxidizing, and less SOD means something an antioxidant was working to counteract the liver damage which would have occurred from bromobenzene. So, there is less superoxide toxicity in these animals. In the case of SOD levels, the only product that brought SOD levels lower than the Model control was the inventive grape product herein disclosed.

The operation and advantages of the present invention will be better understood by those of ordinary skill in the art and others upon reading the ensuing specification when taken In Conjunction with the appended drawings wherein:

### BRIEF DESCRIPTION OF THE DRAWING FIGURES

FIG. 1 is a process flow chart for a method of producing a dry product from source materials including grape cane, fresh grape, and red wine according to this invention;

FIG. 2 is a side elevation diagrammatic view, partially in cross section, of an alternative process for producing a dry product from source materials including grape cane, fresh grape, and red wine in accord with the present invention;

FIG. 3 is a perspective elevation end view of the drying machine seen in FIG. 2; and

FIGS. 4 and 5 respectively illustrate in the form of bar graphs the results of the SOD and MDA testing on mice.

### DETAILED DESCRIPTION OF THE PREFERRED EMBODIMENTS

### A First Process

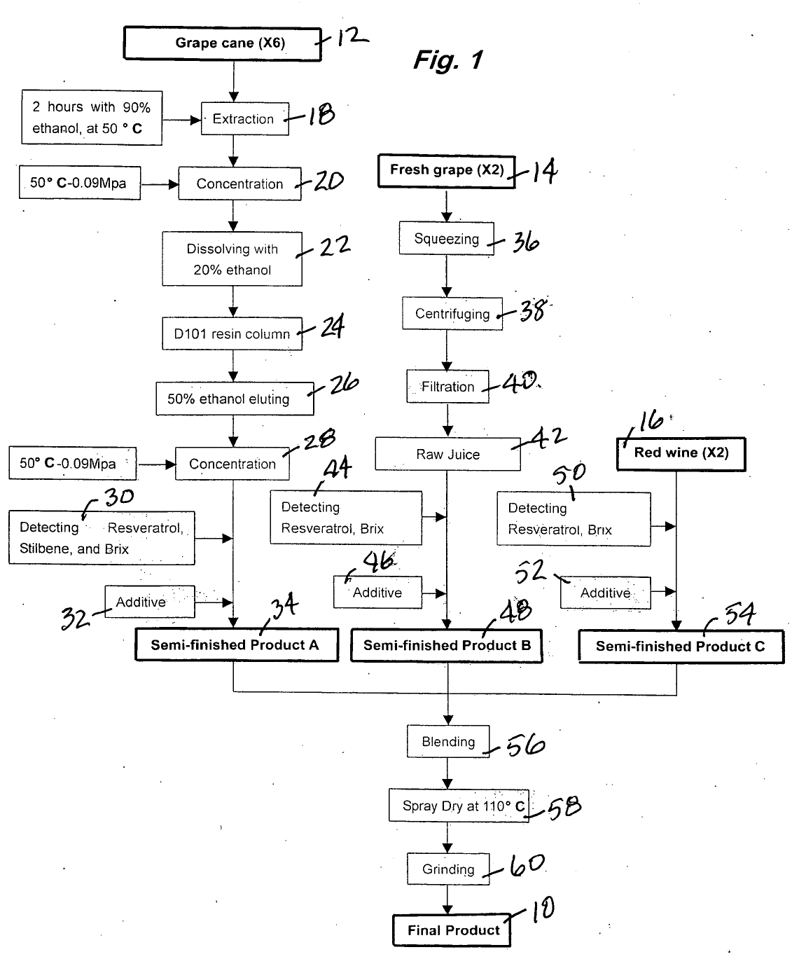

Turning first to FIG. 1, this Figure schematically illustrates a process or method for producing a free-flowing dry crystalline or powder food supplement product 10 using source materials (indicated as 12, 14, and 16). As is indicated on FIG. 1, the source materials 12, 14, and 16 are preferably used in proportions generally indicated on this Figure, although the invention is not so limited. That is, 6 parts of source material 12, to two parts of source material 14, along with 2 parts of source material 16. The source material 12 includes grape cane, which may include Such grape plant materials as stems, branches, skins of the grapes, grape seed, and even leaves. Also included in this term “grape cane” is Such materials as even the leaves and root materials of the grape plant. While the preferred source of these grape plant materials (i.e., the grape cane) is the red grape, white muscadine grapes plants and parts of these grape plants may be included, and especially the seeds of this white muscadine grape. It is important to note that this grape cane source material includes many materials that are simply trimmed off the grape vines during maintenance of a vineyard, and which historically were thrown into a land fill or burned.

Source material 14 includes fresh grapes, and again red grapes are preferred although other grapes such as the white muscadine grape may be included. Source material 16 includes red wine. It will be noted on FIG. 1, that the process parameters are indicated as included 6 measures of material 12, and 2 measures of each of the source materials 14 and 16. These measures are indicated to be by weight, although the proportions of the source materials are not critical to obtaining a beneficial product according to this invention. In other words, the invention is not limited to the proportions of source materials indicated on FIG. 1. The grape cane is most preferably washed to remove debris, and then is ground to a sufficiently small size allowing for efficient solvent extraction before the process of FIG. 1 is begun.

Considering First the processing of the grape cane source material 12, it is seen on FIG. 1 that the grape cane 12 is treated with a 90 percent ethanol solution at approximately 50° C. for a time of about two hours (step 18). The solution is then drained from the grape cane, and this solution of extraction (i.e., from step 18) is concentrated by vacuum concentration or drying at 0.09 Mpa, and 50° C. (step 20). The resulting semi-dry or dry material of extraction (i.e., from step 20) is dissolved with 20 percent ethanol (step 22), and is then passed along a D101 resin column (step 24). The captured extraction material in the resin column of step 24 is eluted using 50 percent ethanol (step 26). Again, the resulting solution now carrying the desired constituents extracted from the grape cane 12 (i.e., placed back into solution at step 26) is vacuum concentrated or dried at 0.09 Mpa, and 50° C. (step 28).

At steps 30 and 32 are illustrated two optional steps, the first (step 30) being an assaying step during which the concentrated or dried material from step 28 is tested for the presence of resveratrol, stilbene, and brix. At step 32 is illustrated the optional addition of additives to the semi-finished product A, which is illustrated at step 34. The semi-finished product A obtained at step 34 is a concentrated extract of grape cane, containing resveratrol, and stilbene.

Turning now to the processing of the flesh grape source material 14, as is seen on FIG. 1, the fresh grape 14 is squeezed (step 36) to provide fresh grape juice (i.e., from step 36). The fresh grape juice from step 36 is then centrifuged (step 38) and filtered (step 40) to provide raw grape juice (i.e., indicated at step 42). Again, the raw grape juice of step 42, as was the case with the concentration 28 of the first process explained above, may be subjected to two additional optional steps, indicated at 44 and 46. Step 44 is all assaying step during which the raw grape juice from step 42 is tested for the presence of resveratrol; stilbene, and brix. At step 46 is illustrated the optional addition of additives to the semi-finished product B, which is illustrated at step 48. The semi-finished product B obtained at step 48 is a raw grape juice containing resveratrol, and stilbene.

Now, consider the processing of the red wine source material 16, as is also seen on FIG. 1. This red wine source material 16, as was the case with the concentration 28 of the first process explained above, and as with the raw grape juice 42 of the second process explained above, may be subjected to two optional steps, indicated at 50 and 52. Step 50 is an assaying step during which the red wine source material 16 is tested for the presence of resveratrol, stilbene, and brix. At step 52 is illustrated the optional addition of additives to the semi-finished product C, which is illustrated at step 54. The semi-finished product C obtained at step 54 is red wine containing resveratrol, and stilbene.

Once the semi-finished Products A, B, and C are obtained as described above, three additional steps are performed to produce the Final product 10. The first of these three additional steps is a blending step indicated at 56. Next, the blended semi-finished product from step 56 is spray dried at step 58 at a low pressure (i.e., perhaps as low as 0.09 Mpa), and at an elevated temperature sufficient to result in a dry crystalline or powder product (i.e., perhaps as high a temperature as 110° C. (step 58). It should be noted that although the temperature used at step 58 may appear to be above boiling point of water, in fact the heat of vaporization of the liquid semi-finished product results in the product not experiencing this temperature fully, so that the chemical constituents of the semi-finished product are not deteriorated by the temperature used in step 58. Finally, a grinding step indicated at 60 is employed to insure that there are no lumps or large crystalline formations included in the free-flowing dry powder product 10 produced by this process.

Further to the above, it is to be noted that a typical chemical analysis of the product made as described above will show:

| | |
|---|---|
| Trans-resveratrol (HPLC) | 0.28% or 2800 mcg/gm |
| Trans-viniferin | 0.32% or 3200 mcg/gm |
| Oligostilibines | 0.80% or 8000 mcg/gm |

The balance of the product is essentially polyphenols. With this product, a preferred dosing for beneficial human consumption of the product is 1 gram per day. However, the invention is not limited to this level of consumption, and a beneficial result may be obtained with dosing as low as about 200 mcg/day or as high as even 20 grams/day. The product may be taken by mixing it with fruit juice, or in the form of capsules or pressed into tablets. Alternatively, the dry powder product may simply be ingested, or perhaps sprinkled on other foods before eating. Importantly, the levels of beneficial grape plant chemicals identified above are also not limiting on this invention. This is because the Finished product identified in FIG. 1, for example, may be further purified to remove larger amounts of the polyphenols, leaving a product which is proportionately higher in concentrations of the trans-resveratrol (.HPLC), trans-viniferin, and oligostilibines. For example, the product can be further refined, it is believed so that the levels of active ingredients are:

| | |
|---|---|
| Trans-resveratrol (HPLC) | 20% or 200 mg/gm |
| Trans-viniferin | 22% or 220 mg/gm |
| Oligostilibines | 57% or 570 mg/gm |

With this level of purification, the polyphenols are reduced to about 1 percent of the product.

### A Second Process and Apparatus

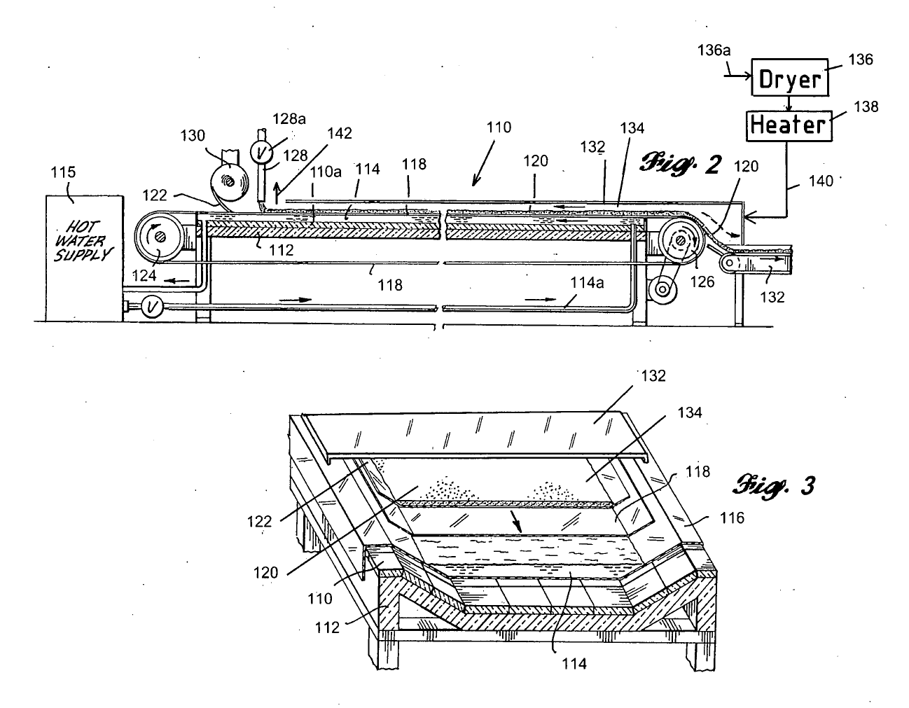

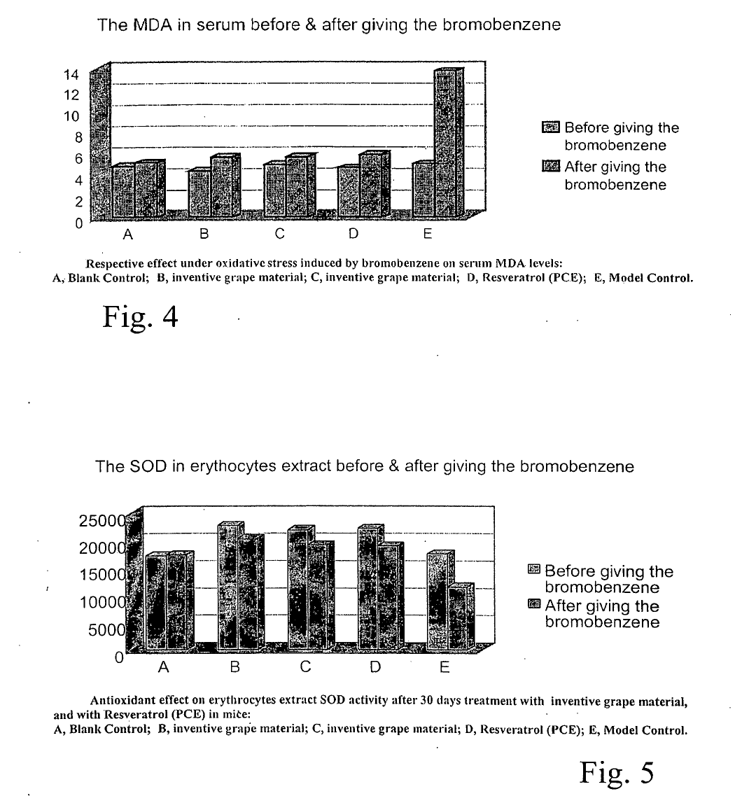

Viewing now FIGS. 2, and 3 in conjunction with one another, another process for producing a dry powder or flake grape product is disclosed. Again, a source material for this process may include red wine, red grapes, red grape plant cane (i.e., sterns, branches, and even leaves), red grape pulp (i.e., grape skins and seeds), white muscadine grapes, wine, and grape plant parts may be included, and especially the seeds of this white muscadine grape). In this case, however, rather than processing the three separate source materials 12, 14, and 16 separately, as in the first process depicted and described above with reference to FIG. 1, the three source materials are all blended together to make a pulp or puree containing approximately the same proportions of the source materials as described above (i.e., a 6 to 2 to 2 ratio).

The resulting pulp or puree is generally a moist fruit or vegetable matter starting material which is provided as described below to a machine 110 for the continuous production of a dry food product from the moist pulp source material according to this invention. The machine 110 is formed somewhat as an elongate trough 110a. The trough 110a is formed of some nonporous medium, such as ceramic tile or sheet metal carried on a supporting and generally insulating substrate or base 112. Heated and counter-flowing water, heated to a temperature close to (but less than) boiling, is provided at the right end of the trough 110a (as seen in the drawing FIG. 2) via a pipeline 114a. This heated water 114 is pumped into the trough 110a from a source 115 of heated water, which may include an electric water heater, or a water heater fueled by any suitable fuel source, such as natural gas, wood, coal, etc.

In practice, the heated water 114 flows into the trough 110a at a first end which is at the right-hand end of the trough 110a as seen in drawing FIG. 2, and the trough is preferably slightly tilted along its length to be higher at the right-hand end so that the heated water (as it loses heat to the drying moist pulp source material, as will be further explained) runs by the force of gravity (see the water flow arrow on FIG. 2) to a second end of the trough 110a, which is the left-hand end as illustrated. From the left-hand end of the trough 110a, the now-cooler water is pumped back to the water heater 115, and is there reheated to the desired temperature. Thus, the heated water is re-used or is re-circulated, is re-heated, and it then pumped once again back into the trough 110a at the right-hand end so that the water in the trough is always maintained close to the predetermined, desired temperature. As will be further explained, however, the water flow is counter to the movement of moist pulp source material along the trough 110a, so that the highest temperature water is exposed to the nearly dried pulp source material, and the cooler water (i.e., cooled by passage along the length of trough 110a) is used to warm the initially room-temperature pulp source material as this pulp source material is delivered onto the trough 110a.

In the illustrated embodiment, a sheet 116, which may preferably be made of polyethylene sheet material, lines the inner surface of the trough 110 and overhangs the edges of the trough to provide an additional moisture and heat barrier between the water and the trough. A flexible sheet of infrared-transparent, and substantially water-impermeable material 118 floats on the surface of the water 114 in the trough 110a. A suitable material has been found to be 300A Mylar, most preferably in a 3-mil-thick sheet. This 300A Mylar material is available from E.I. Dupont De Nemours Co. The 300A Mylar meets all of the requirements of the invention in that it shows very little distortion or shrinkage in the operable temperature range utilized in the machine 110. Further, this 300A material is flexible so that it lends itself to a conveyor belt type of application and also has the strength required to operate for long periods of time without breakage. While the polyester sheet 118 only needs to float on top of the water in the illustrated embodiment, the polyester sheet is wider than the trough 110 so that it not only overlies the water but also rides slightly up the sides of the trough 110a. The extra width of the polyester sheet 118 ensures a complete coverage of the water so that there is no evaporative exposure of the water to the open air above the trough. The overly-wide sheet 118 also provides a channel that keeps the product to be dried 120 (i.e., the pulp source material), which is a mixture, mash, past, slurry, or puree consisting of solid particles in suspension in a liquid which includes fruit juice and red wine, from running off of the polyester sheet into the hot water.

The moist source material to be dried 120, which as explained above, preferably consists of a 6 parts to 2 parts to 2 parts mixture or puree of grape cane, raw grape juice, and red wine, is placed in a thin layer on top of the polyester sheet 118 and remains on the polyester sheet until it reaches the proper consistency or dryness, that is, until a predetermined amount of the moisture is driven off the mixture by the heat transferred from the hot water to the source material through the polyester sheet. It has been found that a thickness of approximately one-eighth to three-sixteenths of an inch for the layer 120 of source material to be dried is capable of producing a satisfactory dried flake or mass of product. In the illustrated embodiment, a thin sheet 122 of material such as polyethylene, for example, 0.5 to 1.5 mils thick, is placed between the polyester sheet 118 and the fruit pulp 120. The polyethylene sheet 122 does not enter directly into the workings of the process of the present invention, but, rather, supplies a convenient medium upon which to place the moist pulp source material to prevent adherence of the pulp to the polyester sheet 118.

The polyethylene sheet 122 is removed from the polyester sheet 118 with the dried material to maintain the polyester sheet 118 in a clean condition for further processing and in a condition suitable for use as a food supplement. Also, the polyethylene sheet 122 separates easily from the Mylar sheet 118 so that the Mylar sheet is not damaged as it might be if it was necessary to scrape the dried pulp directly off of the polyester sheet. The polyethylene sheet 122 and dried flake product can be removed simultaneously from the polyester sheet to provide a convenient method by which the dried product is transported for further processing (i.e., flaking, powdering, or granulizing) and/or stored after its removal from the dryer.

In one preferred form of the invention, the polyester sheet 18 is formed in an endless belt and is carried by a pair of rollers 124 and 126, respectively, mounted at either end of the trough 110a to form a conveyor belt. The moist pulp source material 120 to be dried is introduced onto the polyester sheet at a first end of the trough from a discharge pipe 128 via a valve 128a. Most preferably, the discharge pipe 128 terminates in a spreader nozzle (not shown in the drawing Figures) having a width sufficient to place a wide thin ribbon of the moist pulp source material on the sheet 122. The polyethylene sheet 122 is fed from a roll 130, also at the first end of the trough 110a, so that the pulp 120 lies on the polyethylene sheet 122. It is necessary to keep a slack in the polyester conveyor belt 118 so that the film floats on the water and is not under such tension that it resists contact with the water surface when the moist pulp source material 120 is placed on the belt.

Subsequently, the pulp 120 moves over the counter-flowing hot water 114 on the polyester sheet conveyor belt 118 to the second end of the trough 110a. During this travel, the moist pulp source material 120 is warmed and gives up moisture. Conversely, the counter flowing water 114 is cooled. The speed of the conveyor belt is regulated so that the time that it takes for the moist pulp source material 120 to travel from one end of the trough 110a to the other is sufficient to produce the proper drying of the source material so that it can be removed along with the polyethylene sheet 122 at the second end of the trough 110a in the form of a dry flake or mass. Most preferably, the transit time for the pulp source material and the length of the trough 110a are selected such that a dry flake or mass is provided at the right-hand end of the trough 110a. The polyester belt 118 continues on to return to the left-hand end of the machine 110 under the trough 110a in a typical conveyor belt fashion, while the now-dried source material is moved away on a second conveyor 132.

In one form of the invention, which has been tested, it has been found that moist pulp source material as described above of one-eighth to three-sixteenths inch thickness placed on a Mylar sheet 3 mils thick over a trough of water in which the water depth is approximately one inch and the water is heated to just below the boiling point, that is, just below 100 degrees C., takes approximately at least two and one-half hours to dry to a suitable degree. Typically, the pulp source material 120 may be open to the air during its drying. It may be thought that it would not be desirable to direct any heated or dried air onto the pulp as it dries because this may form an undesirable skin on the top of the pulp and actually impede drying of the pulp by evaporation. This is in fact the case unless the drying air flow stream is properly managed, as will be further explained. An air flow into and out of the room in which the dryer is located is certainly desirable to maintain the room air at a humidity that allows ready evaporation of the moisture in the moist pulp source material 120 to the air and, in fact, dried heated air can be pumped into the room to lower the ambient humidity and increase the rate of absorption of water vapor by the air.

However, it has been found that in order to form a sufficiently dry flake type of product within a reasonable time interval and length for the trough 110a, that the moist pulp source material can be beneficially exposed to a dried and heated air flow, and especially to a confined counter-flow air flow. To this end, a cover 132 may be provided over substantially all of the length of the trough 110a, defining a captive air space 134 which opens to ambient at the left-hand end of the trough 110a, as will be further explained. A dryer 136 receives ambient air 136a, and dries this air (i.e., by desiccant or refrigeration process, for example). The dried air is then supplied to a heater 138 which heats the dry air to a controlled selected temperature well above ambient, and possibly close to but less than boiling point of water, and supplies this dried and heated air via duct 140 into the right hand end of the trough 110a in air space 134.

Because of the counter flow of the dried and heated air relative to the motion of the moist pulp source material 120 (see the air flow arrow on FIG. 2), the tendency to form an undesirable dry crust on the surface of the product is reduced because the product pulp is first exposed (i.e., near the left-hand end of trough 110a) to a warm but humid drying air flow. This air flow has gained substantial humidity by passing along the length of trough 110a over the drying pulp product. So, drying of the pulp product at the left-hand end of the trough 110a is effected by a combination of warm water heating, and heating by warm air that is relatively high in humidity. On the other hand, as the drying product pulp progresses toward the right (viewing FIG. 2) and approaches the right-hand end of the trough 110a, drying is effected by the warmest water in trough 110a in combination with the warmest and driest air in air space 134.

Thus, a dry flake red grape-product is produced at the right-hand end of trough 110a, and is delivered onto conveyor 132, ready for further processing (such as placement in capsules or in bottles, for example). As was the case with the first product depicted and described above by reference to FIG. 1, a grinding step (not indicated on the drawing Figures) is preferably employed with the product of this process as well to insure that there are no lumps or large crystalline formations included in the free-flowing dry powder product provided by machine 110.

Having observed the details of the machine 110 and its operation by attention to FIG. 2, attention may now be directed to FIG. 3, and the details of the method of this second process of the invention. As will be recalled, in accordance with the present method, a reservoir of water, such as in a trough, is heated to some predetermined temperature close to be preferably below the boiling point of water. A thin film of transparent material (i.e., transparent to heat or IR radiation), such as a polyester film, is floated on the water surface in the trough so that it covers substantially the entire open surface area of the water. Because of the floating contact of the film on the water surface and the film covering the water, there is little, if any, evaporation from the water to the air above it. Then, a moist pulp red grape product to be dried, generally in the form of a puree of red grape vegetable materials along with red wine, is placed on the film in heat-transfer contact with the surface of the water.

The contact between the film carrying the red grape and wine product to be dried and the surface of the water enables a transfer of heat directly from the water through the film into the product to be dried causes the moisture in the product to be driven off. Additionally, a counter flow of dry, heated air may be effected above the product to be dried, assisting in producing a dry flake product. After the product to be dried is dried to a consistency of a dry flake or mass, this product is then packaged (possibly with a grinding step to remove lumps and aggregations) in convenient forms for use as a red grape and wine food supplement. For example, the dry product may be placed in capsules, may be pressed into pill form, or may be placed loose as a free-flowing dry powder into bottles.

Further, experiments by the Applicant have shown that the chemical constituents which are believed to be beneficial to humans, and which are present in several plant products, including grapes, raspberries, mulberries, peanuts, berries of the Vaccinium species, including blueberries, bilberries, and cranberries, some pines Such as Scots pine and eastern white pine, and the roots and stalks of giant knotweed and Japanese knotweed, as well as in the Peruvian legume, Cassia quillquallgulata, from which the chemical was first isolated. This chemical is believed to have important health benefits, such as anti-cancer, antiviral, neuroprotective, anti-aging, anti-inflammatory, and life-prolonging effects. For example, fresh grape skin contains about 50 to 100 micrograms of beneficial chemical per gram. It has been found that a dry food supplement made by drying a moist source material originating from a source selected as outlined above retains a substantial content of the beneficial food values, and that because the mass or quantity of the food supplement (compared to its moist state) is substantially reduced, a consumer of the food supplement need not consume nearly as much of the food supplement as they would have to consume of the source material in order to obtain the desired benefits.

I claim:

1. A food supplement produced from a source material selected from the group consisting of: grape cane material, red wine, and grape juice.

2. The food supplement of claim 1, wherein said grape cane source material includes stems and branches of grape plants.

3. The food supplement of claim 1, wherein said grape cane source material is subjected to solvent extraction, and a resulting Solution of extraction is dried to provide a dry powder food supplement material.

4. The food supplement of claim 3, wherein said resulting solution of extraction is blended with raw grape juice and with red wine, and is then dried to provide said dry powder food supplement material.

5. The food supplement of claim 3 wherein said grape cane source material is mixed with raw grape juice, and with red wine to provide a puree of grape cane material, moist with grape juice and red wine, and said puree is then dried by controlled application of heat from hot water at a controlled elevated temperature always less than the boiling temperature of water.

6. The food supplement according to claim 5, wherein said controlled drying of said puree is accomplished by flowing the puree in one direction along an elongate trough while suspended on a heat transfer and moisture impermeable sheet, and flowing heating water in a counter flow direction along said elongate trough in heat transfer relation with a lower side of said sheet.

7. A method of making a grape product food supplement, said method comprising steps of:
providing a first source material including grape cane, said grape cane including parts of the grape vine plant, such as stems and branches;
providing a second source material including raw grape juice; and
providing a third source material including red wine; and
converting said first, said second and said third source materials into a dry powder food supplement product which contains beneficial chemical constituents of the grape.

8. The method of claim 7, wherein said first source material, said second source material, and said third source material are provided at a ratio of about 6:2:2.

9. The method of claim 7 wherein said grape cane is first washed and ground, and is then soaked in an ethanol/water mixture at elevated temperature for a determined time interval to provide a first solution of extraction.

10. The method of claim 9, further including the step of vacuum concentrating said first solution of extraction.

11. The method of claim 10 further including the step of using ethanol dissolution, resin absorption, and ethanol dissolution, followed by another vacuum concentration to provide a semi-finished product of the grape cane source material.

12. The method of claim 11 further including the steps of mixing the semi-finished product of the grape can material with raw grape juice, and with red wine, and spray vacuum drying the resulting mixture to provide a dry powder food supplement product of the grape.

13. A method of providing a dry powder food supplement material of the grape by drying a moist source material, such as a moist paste or slurry of grape cane, grape juice, and red wine to the condition of a dry flake or mass while maintaining a temperature below the boiling point of water, said method comprising the steps of:
(a) positioning and buoyantly supporting a sheet of water-impermeable, heat-transfer material on a body of heated water having a temperature below boiling so that a lower surface of the sheet is in contact with the water;
(b) placing the moist source material to be dried in heat transfer relation above the sheet;
(b) transferring heat from the water through the sheet to the moist product to drive off water from the product; and
(c) continuing drying of the product until it reaches the condition of a dry flake or mass.

14. A method of beneficially supplementing the human diet by use of a food supplement produced from a source material selected from the group consisting of: grape cane material, red wine, and grape juice, said method including steps of:
providing said food supplement, and
ingesting a beneficial daily amount of said food supplement.

15. The method of claim 14, further including the step of including in said food supplement chemicals selected from the group consisting of: trans-resveratrol, trans-viniferin, oligostilibines, and polyphenols.

16. The method of claim 15 wherein said food supplement is provided to include substantially the following levels of said beneficial chemicals:

| | |
|---|---|
| Trans-resveratrol (HPLC) | .28% or 2800 mcg/gm; |
| Trans-viniferin | .32% or 3200 mcg/gm; |
| Oligostilibines | .80% or 8000 mcg/gm; |

With the balance of the food supplement being essentially polyphenols.

17. The method of claim 14 further including the steps of: providing grape cane source material; subjecting said grape cane source material to solvent extraction; blending a resulting solution of extraction from said grape cane source material with raw grape juice and with red wine; and drying a resulting blend of said Solution of extraction from said grape cane source material, said grape juice, and said red wine to provide a dry powder food supplement material.

18. The method of claim 14 further including the steps of: providing grape cane source material; grinding said grape cane source material to a sufficiently small particle size, mixing said ground grape cane source material with grape juice and with red wine to produce a puree of ground grape cane source material, grape juice and red wine, and drying said puree to a powder at a temperature always below the boiling point of water to produce a dry power food supplement.

19. The method of claim 18 wherein said drying step includes the steps of: subjecting said puree to controlled application of heat from hot water at a controlled elevated temperature always less than the boiling temperature of water; and accomplishing said controlled application of heat by flowing the puree in one direction along an elongate trough while suspended on a heat transfer and moisture impermeable sheet while flowing heating water at a temperature below boiling in a counter flow direction along said elongate trough in heat transfer relation with a lower side of said sheet.
